(19) United States
(12) Patent Application Publication
(10) Pub. No.: US 2007/0078763 A1
(43) Pub. Date: Apr. 5, 2007

(54) Method and system for transferring funds between two phone callers

(76) Inventors: Rene Pierre Babi, Vancouver, WA (US); Mark Mathias Silbernagel, Battle Ground, WA (US)

Correspondence Address: Lawrence D. Eisen;Pillsbury Winthrop Shaw Pittman LLP, 1650 Tysons Boulevard, McLean, VA, 22102, US

(21) Appl. No.: 11/528,554

(22) Filed: Sep. 28, 2006

Related U.S. Application Data
(60) Provisional application No. 60/722,008, filed on Sep. 30, 2005.

(51) Int. Cl. G06Q 40/00

(52) U.S. Cl. 705/39

(57) ABSTRACT

A system and method for enabling transfer of funds between two people engaged in a telephone communication. The method includes monitoring for a predetermined series of key presses by an initiator that are entered during the course of the telephone communication. In one embodiment, a funds transfer initiator account is identified based on automatic number identification (ANI) and a funds transfer recipient account is identified by detecting dialed number identification service (DNIS). With these accounts so identified, the initiator of the funds transfer is prompted to enter an amount of funds to be transferred and, thereafter, such funds are caused to be transferred from the initiator's account to the recipient's account, all while the initiator and the recipient are still engaged in the telephone communication.

This application claims the benefit of U.S. Provisional Application No. 60/722,008, filed Sep. 30, 2005, which is herein incorporated by reference in its entirety

### FIELD OF THE INVENTION

Embodiments of the present invention are related to finance, banking, money transfers, and the like. More particularly, the present invention is directed to methods and systems for transferring funds between people during an on-going telephone call.

### BACKGROUND OF THE INVENTION

While there are many means of transferring funds between a business and an individual, in real time or nearly so, there are far fewer solutions for use between two individuals.

Checks are one solution, but they are by nature a fairly slow means of accomplishing a transfer with an uncertain time frame for completion and the possibility of insufficient funds, stop payments, or charge-backs essentially reversing a transaction (risk).

Cash works in face to face circumstances without the above mentioned risks, but this modality limits its usefulness to cash-on-hand (availability, liquidity) and geography. Cash can also have the added complexity of currency exchange.

Some person to person mediated services have emerged on the Internet, such as PayPal, but the internet is increasingly a risky medium, and as successful as PayPal has been, its market share is by no means pervasive. Many other similar services are available on the Internet as well—each with similar risk issues. Of course, identity theft and associated fraud are real and constant risks for any Internet facilitated system.

There is accordingly a need for improved methodologies for allowing two people to agree to and execute funds transfer transactions.

### SUMMARY OF THE INVENTION

The methods and systems described herein provide a means to accomplish quick, easy, and safe person to person funds transfers between two callers who are (ideally) being serviced by the same cellular telephone system, although the methods and systems described herein can be accomplished with nearly the same effort as long as at least one of the phones is part of the system used to enable the transfer.

More specifically, embodiments of the present invention enable funds transfer between two callers on the same, e.g., cellular system. In one embodiment, a system monitors the call for touch-tone (DTMF—“Dual Tone Multiple Frequency”) key presses initiated by either caller. Upon hearing the proper sequence, the party initiating the transfer can be led through steps necessary to transfer the desired funds to the other party's account. The other party can witness (listen to the prompts and confirmations) the transfer and be assured of its completion. As will be explained in more detail below, when both phones are part of the same system (best case) there is increased assurance that the system has properly identified both the phone number and any associated account numbers of both parties in the call. In addition, the system has legitimate access and control of the communications channel.

These and other features of the present invention, along with their attendant advantages are described below in association with several drawing figures.

### BRIEF DESCRIPTION OF THE DRAWINGS

FIG. 1 depicts a high level system architecture for implementing embodiments of the present invention.

FIG. 2 is a sequence diagram illustrating an exemplary sequence of steps in accordance with the present invention.

FIG. 3 depicts another high level system architecture for implementing embodiments of the present invention.

FIG. 4 shows an exemplary flow diagram for performing steps in accordance with the present invention.

### DETAILED DESCRIPTION OF THE INVENTION

In the ideal case, two telephone users are both serviced by the same cellular or mobile system, although the method and system described herein would also work when the phones are part of different PSTN or cellular systems. It is more ideal to have the phones in the same system since it is more likely that less fraud can take place in that the single system has more general control over the progression of a given call.

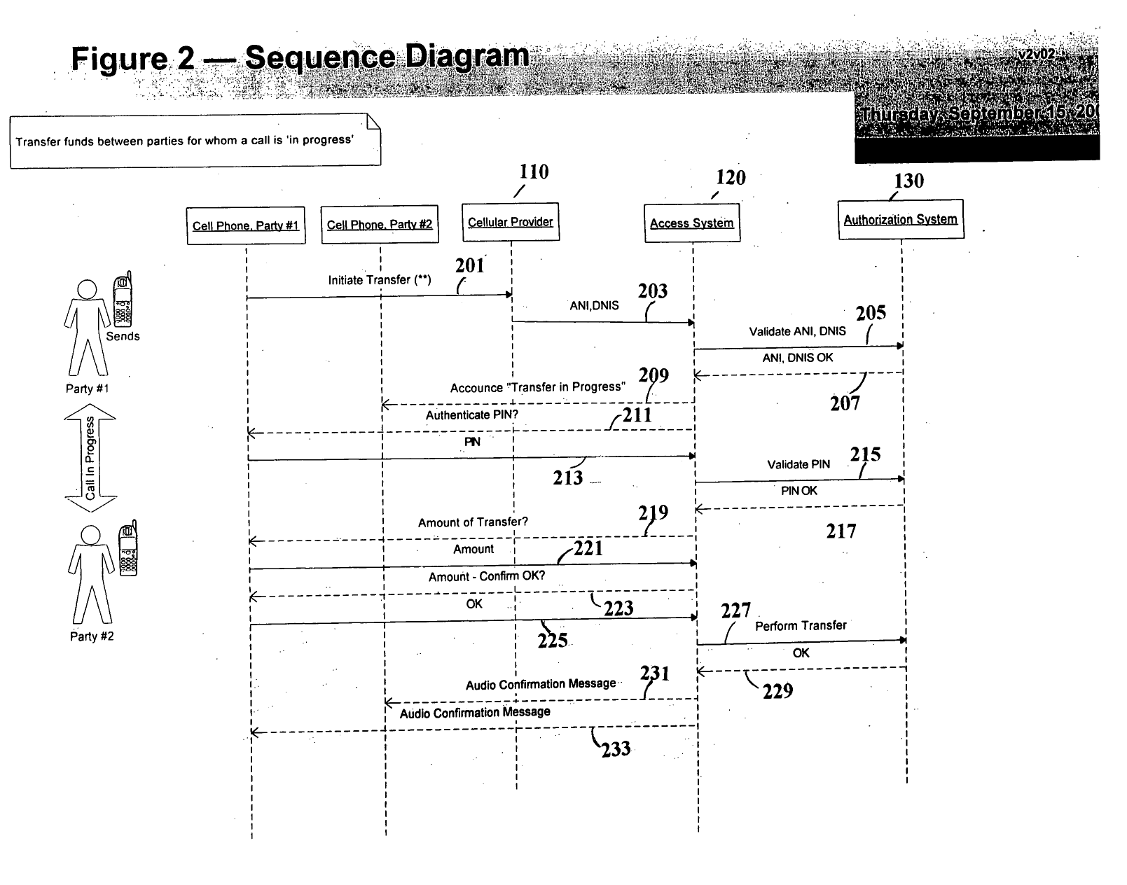

For purposes of explanation, assume the two phones are phone #1 (P1) and phone #2 (P2), as shown if FIG. 2. Once either party has called the other, a communications channel exists between P1 and P2. In accordance with embodiments of the present invention, the cellular system's equipment monitors each phone's outbound channel for key presses, detecting (standard) DTMF tones generated by a key press in the audio channel. In one implementation of the present invention, a sequence of tones can be designated to indicate the beginning of a transfer, and, optionally, at the same time, signal the system NOT to forward the tones to the other party (both for security, and listening comfort).

Once a sequence of key presses is detected, e.g., two “*” key presses within 1.5 seconds, the system may direct a voice prompt to the party initiating the call. For the following example, P1 is considered the initiator. Optionally, P2 can listen to prompts which are informational in nature as the transaction progresses. Optionally, P1 and P2 can continue to speak to each other when DTMF tones are not present—possibly to confirm necessary information or even cancel the transaction.

Having initiated the transfer, P1 is now preferably led through a series of prompts to accomplish the transfer. Where appropriate, P2 is allowed to hear those prompts, and where appropriate P2 may be allowed to hear P1's response or a ‘voiced’ interpretation of P1's response (e.g. text to speech) so that P2 does not have to “translate” DTMF to know what is happening.

The following provides an outline to the methodology just described:
1. The sending party (or initiator), implicitly, is P1, because P1 initiated the transfer using (in the instant example) “**”
2. The receiving party (or recipient), implicitly, is P2.
3. P1 is prompted for an amount.
4. P1 is asked to confirm the amount.
5. Optionally, P2 may be prompted with an offer to accept a transfer (the amount could be “voiced” using text-to-speech) to their account, and if this option is employed they would additionally be prompted to accept or reject the transfer.
6. If P1, and optionally P2, accept the transfer, a funds transfer is initiated from the sender's or initiator's (P1) associated account to the recipient's (P2) associated account.
7. Upon confirmation or rejection of the offer to transfer funds, the system may play an appropriate message to both P1 and P2 indicating either a successful or cancelled transaction.

At this point, normal conversation may continue.

In the case where only one phone is part of the “system” (for example, P1), the “in system” phone would be allowed to initiate the transfer and all other steps would apply normally.

If the mediating system operators were willing to accept risk, or with the addition of a step to confirm identity of the off-system party (P2) such as a password or PIN, etc., the one-phone version could safely facilitate transfers in either direction.

A nearly identical means of implementing this method would be to allow parties from any phone system to call a “funds transfer conferencing system” and accomplish the transfer in the manner of a conference call, with the added requirement to improve security by requesting identity confirmation from all non-system parties.

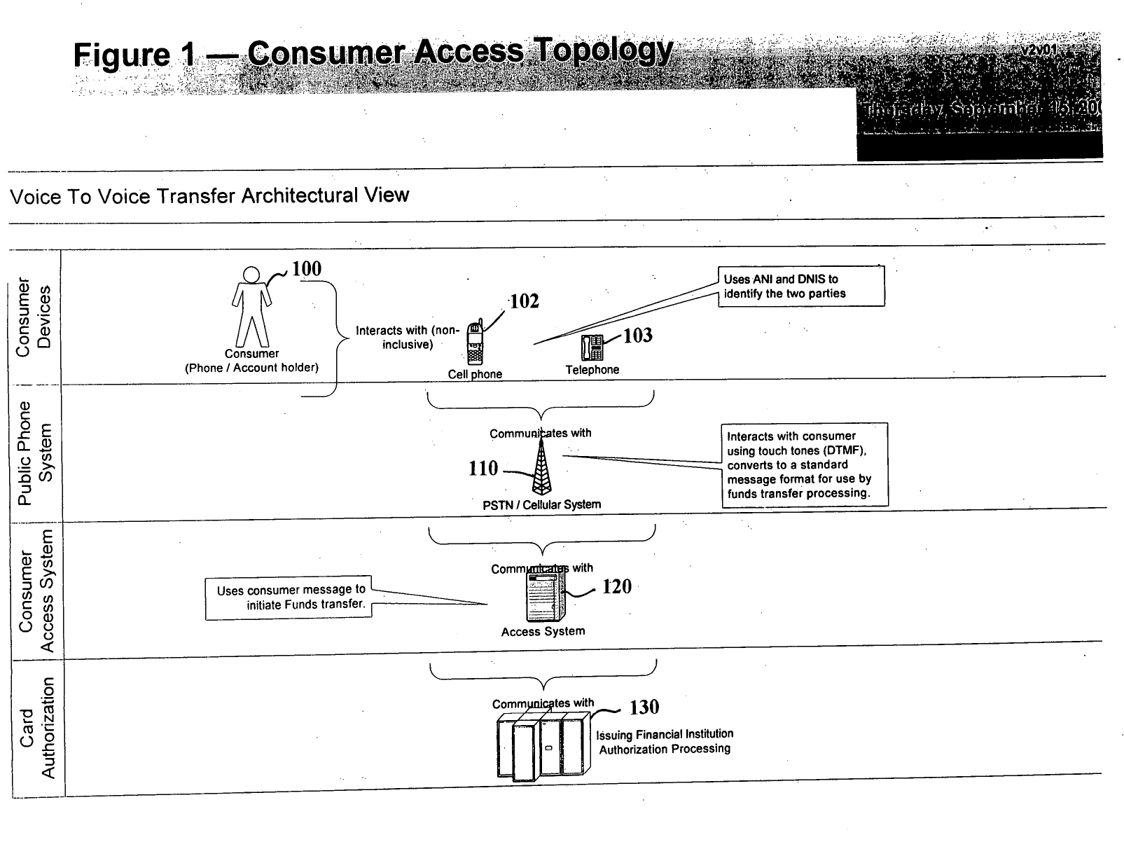

Turning now to FIG. 1, there is shown a high level architecture of a system for implementing embodiments of the present invention. As shown, a consumer 100 is both a telephone user and has some type of account (e.g., credit card, debit, checking, etc.), and can interact with or make use of a cellular phone 102 or a regular telephone 103. Phones 102 and 103 communicate with a public switched telephone network (PSTN) or cellular system 110. As is well known by those skilled in the art, part of fundamental telephone signaling includes ANI (Automatic Number Identification) and DNIS (Dialed Number Identification Service), which identify both the calling party and called party.

By having the ability to automatically identify both the calling and called party, the system of the present invention is also able to associate both of those parties with accounts belonging to the parties. This can be accomplished by a database resident at the PSTN/cellular system 110 or alternatively, with an access system 120 and associated database as shown in FIG. 1.

As further shown in FIG. 1, PSTN/cellular system 10 interacts with consumer 100 using, e.g., touch tones (DTMF). These tones are thereafter converted to a standard message format for use by an issuing financial institution and authorization processing system 130, which performs the actual funds transfer transaction.

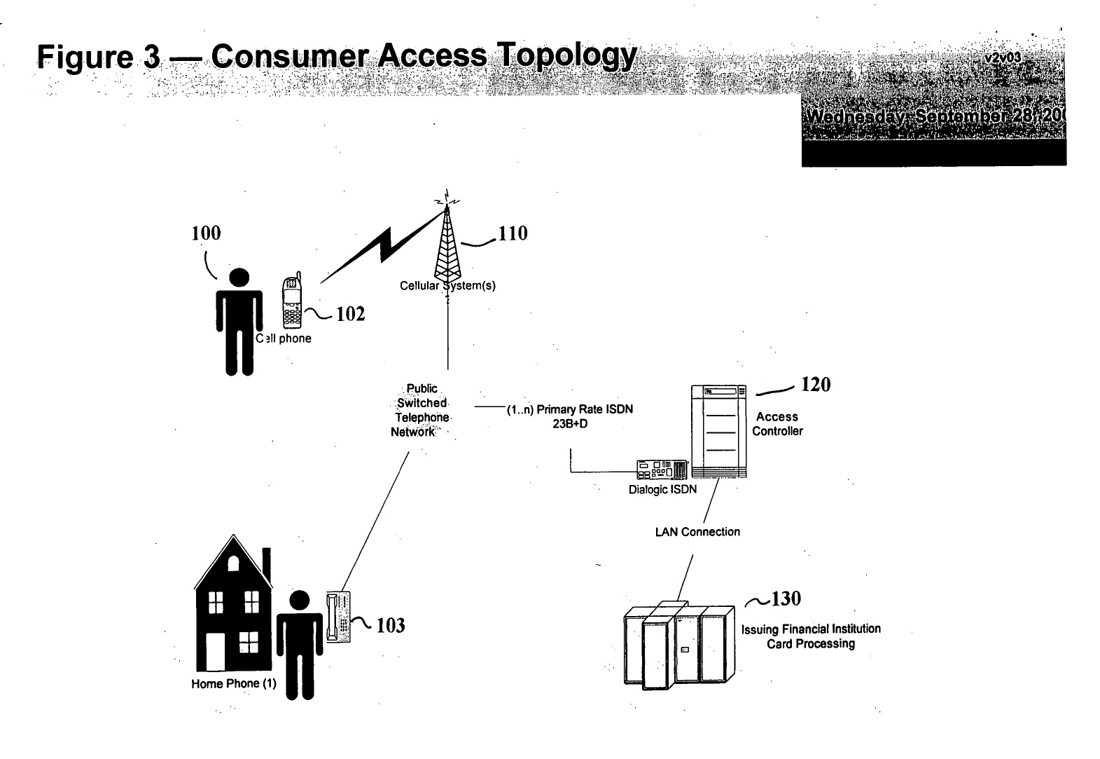

Simply stated, a consumer 100, using a phone 102 or 103 and PSTN/cellular system 110, gains access to an access system 120 via which commands to a financial institution can be sent, thereby enabling one telephone call participant to transfer funds from an account belonging to that participant to an account belonging to a second telephone call participant. FIG. 3 also depicts, in a somewhat different way, what is described above.

Where a funds transfer conferencing system is implemented, access system 120 may act as such a system.

FIG. 2, shows an exemplary sequence diagram for implementing an embodiment of the present invention. As is generally shown on the left hand side of FIG. 2, party #1 is in an on-going telephone call with party #2. Party #1 initiates a transfer using for example, two asterisks (**) at step 201, which are detected by the cellular provider 110. In response, the cellular provider passes ANI and DNIS data to the access system 120, at step 203. (It is noted that it is also possible to pass, in the case of a mobile telephone system, the electronic identification number (EIN) or International Mobile Equipment Identity (IMEI) of the phone of one or both parties for identification purposes.) The ANI and DNIS information is thereafter validated by an authorization system 130 (step 205) and an acknowledgement or “OK” message is returned to access system 120 from authorization system 130, at step 207. At that point, at step 209, a message may be announced such as “transfer in progress” (to one or both parties) and requests the initiating party in this case, Party # 1, to enter a personal identification number or PIN (step 211). The PIN is then sent by Party #1 (step 213) and then, preferably, validated by the authorization system 130 (step 215). An acknowledgement or “OK” message is may then be returned to access system 120 (step 217).

Access system 120 then, at step 219, requests the initiating party to enter an amount for the funds transfer. In response, Party #1, in this case, enters an amount which is passed to access system 120 (step 221). In turn, access system 120 requests confirmation of the amount so entered (step 223). When a confirmation is received from the initiating party at the access system 120 (225), access system 120 then generates a message that is sent to authorization system 130 to perform the funds transfer (step 227). The accounts between which funds are transferred are preferably previously associated with the parties telephone numbers (which, as noted previously were captured with ANI and DNIS, or other identification data). Of course, those skilled in the art will appreciate that an account number from which and/or to which the funds will be transferred could instead be entered by either Party #1 or Party #2, rather than relying on an automated association of an account with one or both parties.

After the transfer is completed (or at least registered for later execution), an acknowledgement or “OK” message is preferably then returned by authorization system 130 to access system 120 (step 229), and audio confirmation messages are preferably sent to each of the parties involved in the funds transfer (steps 231, 233).

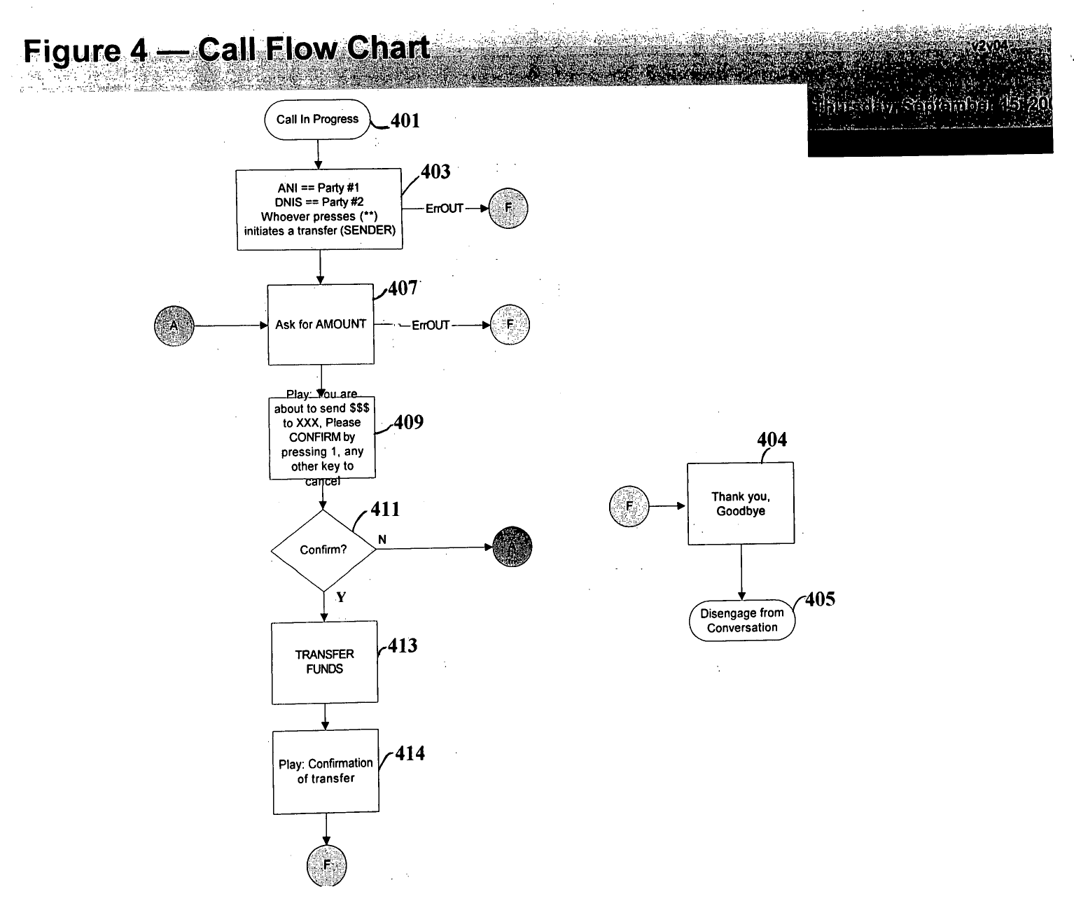

FIG. 4 illustrates a similar series of steps as described above with respect to the sequence diagram of FIG. 2, but does so in the form of a flowchart. More specifically, step 401 shows a call in progress between two parties. At step 403, ANI and DNIS are detected. If an error is encountered, for any number of reasons (e.g., connection is lost, ANI or DNIS could not be established with certainty, the key presses were inconclusive, etc.), the process is halted and passed to steps 404 and 405 where the process is effectively terminated.

At step 407, the initiator is prompted or asked for an amount to be transferred and then at step 409 the initiator is asked to confirm that amount. If the amount is not confirmed then the routine returns to step 407 to ask again for the amount of transfer. Assuming the transfer amount was confirmed at step 409, the transfer is executed at step 413 and a confirmation message is preferably played for one or both parties at step 414. The process ends via steps 404 and 405.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. For instance, the “accounts” described herein should be understood to also broadly include debit cards, checking cards (open-loop), and even closed-loop cards.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on any claims.

What is claimed is:

1. A method for enabling transfer of funds between two people engaged in a telephone communication, comprising:
monitoring for a predetermined series of key presses by an initiator;
identifying a first account associated with the initiator;
identifying a second account associated with a recipient;
prompting the initiator, in response to the predetermined series of key presses, to enter an amount of funds to be transferred; and
causing said amount of funds to be transferred from said first account to said second account while the initiator and the recipient are still engaged in the telephone communication.

2. The method of claim 1, wherein the key presses are Dual Tone Multiple Frequency (DTMF) tones.

3. The method of claim 1, wherein the telephone communication occurs over a mobile telephone network.

4. The method of claim 3, wherein the initiator and recipient are serviced by a same mobile telephone service provider.

5. The method of claim 1, wherein the first account is associated with the initiator by detecting mobile identification data associated with the initiator.

6. The method of claim 5, wherein the mobile identification data comprises a telephone number belonging to the initiator that is detected using automatic number identification (ANI).

7. The method of claim 5, wherein the mobile identification data comprises at least one of an Electronic Identification Number (EIN) and an International Mobile Equipment Identity (IMEI).

8. The method of claim 1, wherein the second account is associated with the recipient by detecting mobile identification data associated with the recipient.

9. The method of claim 7, wherein the mobile identification data comprises a telephone number belonging to the initiator that is detected using dialed number identification service (DNIS).

10. The method of claim 8, wherein the mobile identification data comprises at least one of an Electronic Identification Number (EIN) and an International Mobile Equipment Identity (IMEI).

11. The method of claim 1, further comprising allowing the recipient to listen to the prompting step.

12. The method of claim 1, further comprising prompting the initiator to confirm the amount of funds to be transferred.

13. The method of claim 1, further comprising providing an audio confirmation of the funds transfer to at least one of the initiator and recipient.

14. A method for enabling transfer of funds between two people engaged in a telephone communication, comprising:
monitoring for a predetermined series of key presses by an initiator;
identifying a first account associated with the initiator by detecting automatic number identification (ANI);
identifying a second account associated with a recipient by detecting dialed number identification service (DNIS);
prompting the initiator to enter an amount of funds to be transferred; and
causing said amount of funds to be transferred from said first account to said second account while the initiator and the recipient are still engaged in the telephone communication.

15. The method of claim 14, wherein the key presses are Dual Tone Multiple Frequency (DTMF) tones.

16. The method of claim 14, wherein the telephone communication occurs over a mobile telephone network.

17. The method of claim 16, wherein the initiator and recipient are serviced by a same mobile telephone service provider.

18. The method of claim 14, further comprising prompting the initiator to confirm the amount of funds to be transferred.

19. The method of claim 14, further comprising providing an audio confirmation of the funds transfer to at least one of the initiator and recipient.

20. A method for enabling transfer of funds between two people engaged in a telephone communication, comprising:
receiving, at a funds transfer conferencing system, a telephone call from an initiator and a telephone call from a recipient;
identifying a first account associated with the initiator by detecting automatic number identification (ANI);
identifying a second account associated with a recipient by detecting ANI;
monitoring for a predetermined series of key presses by the initiator to initiate a process to transfer funds;
prompting the initiator to enter an amount of funds to be transferred; and
causing said amount of funds to be transferred from said first account to said second account while the initiator and the recipient are still engaged with the funds transfer conferencing system.

21. The method of claim 20, wherein the telephone communication occurs over a mobile telephone network.

22. The method of claim 21, wherein the initiator and recipient are serviced by a same mobile telephone service provider.
